(19) United States
(12) Patent Application Publication
(10) Pub. No.: US 2024/0378073 A1
(43) Pub. Date: Nov. 14, 2024

(54) MULTI-MODAL MEMORY SUB-SYSTEM WITH MULTIPLE PORTS HAVING SCALABLE VIRTUALIZATION

(71) Applicant: Micron Technology, Inc., Boise, ID (US)

(72) Inventor: John E. Maroney, Irvine, CA (US)

(21) Appl. No.: 18/647,548

(22) Filed: Apr. 26, 2024

Related U.S. Application Data
(60) Provisional application No. 63/465,811, filed on May 11, 2023.

(51) Int. Cl. G06F 9/455; G06F 13/42

(52) U.S. Cl. CPC G06F 9/45558; G06F 13/4221; G06F 2009/45579; G06F 2009/45583; G06F 2009/45595

(57) ABSTRACT

A memory sub-system that supports both PCIe and ethernet, without a separate switch or bridge, includes a processing device to detect a first host system connected to a first interface port of the plurality of interface ports of the memory device. The processing device further detects a second host system connected to a second interface port of the plurality of interface ports. The processing device further assigns a first subset of a plurality of virtual functions (VF)s associated with the memory device to the first host system using root input/output virtualization (SR-IOV) and assigns a second subset of the plurality of VFs to the second host system using SR-IOV. The processing device further allocates a first corresponding range of logical block addresses (LBA) to each VF of the first subset of VFs and allocates a second corresponding range of LBAs to each VF of the second subset of VFs.

### CROSS REFERENCE TO RELATED APPLICATIONS

This patent application claims priority to U.S. Provisional Patent Application No. 63/465,811 filed on May 11, 2023, entitled “MULTI-MODAL MEMORY SUB-SYSTEM WITH MULTIPLE PORTS HAVING SCALABLE VIRTUALIZATION,” the entire contents of which is incorporated herein by reference.

### TECHNICAL FIELD

The present disclosure generally relates to a memory system, and more specifically, relates to a multimodal memory sub-system with multiple ports having scalable virtualization.

### BACKGROUND

A memory sub-system can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 illustrates an example computing system that includes a memory sub-system with multiple ports that have scalable virtualization, in accordance with some embodiments of the present disclosure.

FIG. 3 illustrates virtual functions memory portion mapping in memory sub-system for SR-IOV/S-IOV virtualization in accordance with some embodiments of the present disclosure.

FIG. 4 illustrates an example multimodal memory sub-system with multiple ports that have scalable virtualization, in accordance with some embodiments of the present disclosure.

FIG. 5 illustrates an example multimodal memory sub-system with multiple ports that have scalable virtualization, in accordance with some embodiments of the present disclosure.

FIG. 6 is a flow diagram of an example method of managing multiple SR-IOV/S-IOV enabled interface ports of a memory sub-system, in accordance with some embodiments of the present disclosure.

FIG. 7 is an example method of assigning virtual functions to virtual machines, in support of multiple SR-IOV/S-IOV enabled interface ports of a memory sub-system, in accordance with some embodiments of the present disclosure.

FIG. 8 is a block diagram of an example computer system in which embodiments of the present disclosure can operate.

### DETAILED DESCRIPTION

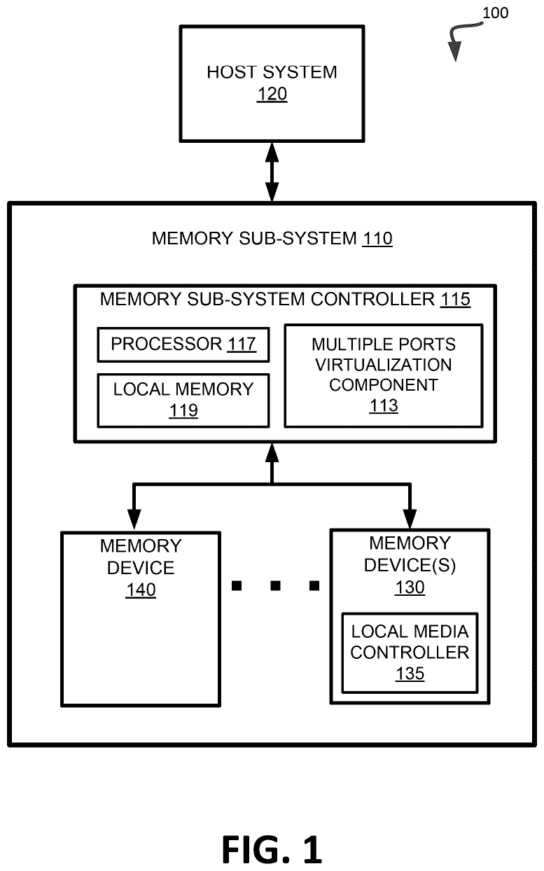

Aspects of the present disclosure are directed to supporting multiple ports having single root input/output virtualization (SR-IOV) or scalable input/output virtualization (S-IOV) in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

In a memory sub-system, a single interface port can be used to transmit data between the memory sub-system and a host system. Multiple hosts running virtual machines can interact with the memory sub-system. A virtual machine can provide an emulation of a physical host system or other such physical resources of a host system. Thus, the memory sub-system can be used to store and retrieve data for the virtual machines that are running on the host systems. In order to manage the transmission of data from the memory devices of the memory sub-system to the virtual machines at the host systems, the storage resources of the memory sub-system can be shared through the use of a single interface port that utilizes a single root input/output virtualization (SR-IOV). In some embodiments, the SR-IOV can provide isolation of the resources of an interface, such as the Peripheral Component Interconnect Express (PCIe), which is used to read data from and write data to the memory sub-system by the different virtual machines. For example, the SR-IOV can provide different virtual functions (VFs) that are each used by a separate virtual machine. A PCI Express (PCIe) virtual function (VF) is a lightweight PCIe function on a network adapter that supports single root I/O virtualization (SR-IOV). The VF is associated with the PCIe Physical Function (PF) on the network adapter, and represents a virtualized instance of the network adapter. Each VF has its own PCI Configuration space. Each VF also shares one or more physical resources on the network adapter, such as an external network port, with the PF and other VFs.

If the memory sub-system is used by multiple host systems, then the single interface port of the memory sub-system can be used to share the storage resources of the memory sub-system with the virtual machines running on the host systems. In order to manage the utilization of multiple host systems with the single interface port, a switch can be used as an intermediary between the memory sub-system and each of the host systems. For example, the switch can be a PCIe switch that provides access to the memory sub-system through the single interface port for each of the host systems. The switch can thus expose the single interface port that utilizes the single root input/output virtualization to each of the different host systems sequentially (i.e., during different access time periods). For example, all virtual functions provided by the SR-IOV can be exposed to all host systems. However, the utilization of a separate switch can add cost and power consumption expenses to the memory sub-system as the switch is a separate and discrete component that is to be coupled with the host systems. Additionally, the separate switch presents a risk of a single point of failure of the memory sub-system because all host systems are connected to the memory sub-system using the switch, thus a failure in the switch can cause all host systems to fail to connect to the memory sub-system.

Aspects of the present disclosure address the above and other deficiencies by introducing multiple interface ports in a memory sub-system, such that the memory sub-system can be shared for storage by multiple host systems. Each of the multiple interface ports supports virtualization, including single root input/output virtualization (SR-IOV) and scalable input/output virtualization (S-IOV). For example, multiple single root input/output virtualization (SR-IOV) enabled interface ports or multiple scalable input/output virtualization (S-IOV) enabled interface ports can be provided by the memory sub-system to enable access to multiple host systems without a need for a separate switch or a bridge. An interface port can be a PCIe port, an Ethernet port, or a physical port. Multiple interface ports of the memory sub-system can be accessed concurrently with each other, such that multiple host systems can access the memory sub-system at the same time, or at least during partially overlapping access time periods. Each interface port (e.g., PCIe interface ports and ethernet ports) can use SR-IOV/S-IOV to provide a separate group of virtual functions to each host system. In some implementations, the memory sub-system can have a maximum number of virtual functions that can be provided by the memory sub-system. Therefore, if the memory sub-system provides a large number of interface ports, each port can be assigned a fewer number of virtual functions, such that the total number of virtual functions assigned to all ports does not exceed the maximum number of virtual functions supported by the memory sub-system. Similarly, if the memory sub-system provides a fewer number of interface ports, each port can be assigned more of the total virtual functions of the memory sub-system.

In some embodiments, the memory sub-system can include two or more SR-IOV/S-IOV enabled interface ports. For example, the memory sub-system can be utilized by two or more host systems where multiple virtual machines can be running on each host system. Each interface port (e.g., a PCIe port, ethernet port) can be SR-IOV/S-IOV enabled and thus can provide a group of virtual functions to the virtual machines of one of the host systems. SR-IOV is a specification that allows the isolation of peripheral component interconnect (PCI) Express (PCIe) resources among various hardware functions for manageability and performance reasons, while also allowing a single physical PCIe device to be shared in a virtual environment. SR-IOV and S-IOV offer different virtual functions (VFs) to different virtual components (e.g., a network adapter) on a physical server machine. SR-IOV and S-IOV also allow different virtual machines in a virtual environment to share a single PCIe or ethernet hardware interface, without sacrificing performance.

In one implementation, the memory sub-system may use hardware-assisted virtualization techniques, such as input/output memory management units (IOMMUs) or direct memory access (DMA) remapping, for creating multiple virtual instances of the physical device, each of which can be assigned to a different virtual machine. One of the benefits of using IOMMUs is that they provide memory protection and isolation for input/output operations. By mapping each VM's virtual addresses to a separate set of physical addresses, the IOMMU ensures that one VM cannot access the memory used by another VM. This provides an additional layer of security and helps prevent attacks such as buffer overflow attacks and other types of memory-based attacks. The memory sub-system can provide an identification of each interface port (e.g., an address or other such identification) and a group of virtual functions supported by the SR-IOV/S-IOV enabled interface port to a group of virtual machines of a host system. Each virtual machine of the host system can be assigned one virtual function of the interface port. As such, since the memory sub-system provides multiple interface ports and each port exposes a separate group of virtual functions that can be utilized by a different host system, the use of a switch or a bridge between the memory sub-system and the host systems is not needed.

In some embodiments, each virtual function can be assigned a namespace or a portion of the logical block address space of the memory sub-system. For example, each virtual machine that is assigned a different virtual function can have access to a different portion of the logical block address (LBA) space of the memory sub-system. The logical block address space can be mapped to a physical block address space of the memory sub-system. Each virtual instance has its own virtual function (VF) identifier, which is used by the hypervisor to map input/output requests from the virtual machine to the appropriate virtual instance. This allows multiple virtual machines to access the physical device simultaneously, without any interference or performance degradation.

In some embodiments, the memory sub-system controller can divide its total bandwidth between the different interface ports. Accordingly, each interface port can be coupled with a separate internal memory buffer of the memory sub-system controller that can be used to temporarily store data received from a respective interface port and/or received from the controller to be transmitted over the respective interface port.

Advantages of the present disclosure include, but are not limited to, a decrease in overall cost of utilizing a memory sub-system with multiple host systems since the utilization of separate switches or bridges is not needed. As the utilization of Multi-host SOC and Multi-VM (virtual machine) virtualized environments is becoming more common in enterprise data centers (e.g., automotive IVI (In-Vehicle Infotainment), ADAS (advanced driver assistance systems), etc.), a decrease in cost and power consumption of multi-host SOCs is desirable. Further, the elimination of the utilization of a separate switch further eliminates a single point of failure (i.e., the separate switch). Because access is provided to the multiple hosts using separate interface ports, a failure in one port will only affect the host system(s) connected to the failure-impacted port, while the other ports can continue to function as expected, thus improving the reliability of the memory sub-system. Additionally, the power consumption of the memory sub-system can be reduced because a separate switch is not included in the memory sub-system. Further, the use of SR-IOV/S-IOV eliminates the need for a hypervisor to virtualize the storage environment. Thus the software overhead introduced by the hypervisor can be eliminated, saving significant cost and power at the system level and allowing a bare metal connection between the memory sub-system and the host SOC.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIBM (SO-DIMM), and a non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the PCIe interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory. A 3D cross-point memory device is a cross-point array of non-volatile memory cells that can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased.

Although non-volatile memory components such as 3D cross-point type and NAND type flash memory are described, the memory device 130 can be based on any other type of non-volatile memory, such as read-only memory (ROM), phase change memory (PCM), magneto random access memory (MRAM), negative-or (NOR) flash memory, electrically erasable programmable read-only memory (EEPROM), and a cross-point array of non-volatile memory cells.

One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units (Mus).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory sub-system 110 includes multiple ports virtualization component 113 that can be used to support multiple SR-IOV enabled ports in a memory sub-system, such that the memory sub-system can be shared for storage by multiple host systems. In implementations, memory sub-system 110 can be shared by multiple host systems using multiple SR-IOV enabled interface ports of the memory sub-system 110, without a need for a separate switch. (e.g., a multi-host capable PCIe switch). The multiple interface ports of memory sub-system 110 can run concurrently with each other, such that the multiple host systems can access memory sub-system 110 at the same time, or at least partially overlapping in time, by allowing each host system to connect to one interface port pf the memory sub-system. Each interface port (e.g., PCIe interface port, ethernet port) can use SR-IOV to provide a group of virtual functions of memory sub-system 110 to the host system connected to the interface port. In implementations, memory sub-system 110 can have a maximum number of virtual functions that can be provided by the memory sub-system. In this case, the number of virtual functions assigned to each interface port can be determined by dividing the total number of virtual functions of the memory sub-system by the number of interface ports of memory sub-system 110.

In implementations, memory sub-system 110 can include two or more SR-IOV/S-IOV enabled interface ports. For example, the memory sub-system can be utilized by two or more host systems 120 where multiple virtual machines can be running on each host system. Each interface port (e.g., a PCIe port or an ethernet port) can be SR-IOV enabled and thus can provide a group of virtual functions to the virtual machines of one of the host systems. SR-IOV is a specification that allows the isolation of peripheral component interconnect (PCI) Express (PCIe) resources among various hardware functions for manageability and performance reasons, while also allowing a single physical PCIe device to be shared in a virtual environment. SR-IOV offers different virtual functions (VFs) to different virtual components (e.g., a network adapter) on a physical server machine. SR-IOV also allows different virtual machines in a virtual environment to share a single PCIe hardware interface. Scalable I/O virtualization (SIOV) allows multiple virtual machines (VMs) to share a single physical device, such as a network adapter or storage controller, without sacrificing performance. SIOV uses hardware-assisted virtualization techniques, such as input/output memory management units (IOMMUs) or direct memory access (DMA) remapping, to create multiple virtual instances of the physical device, each of which can be assigned to a different virtual machine.

In one implementation, multiple ports virtualization component 113 can provide an identification of each interface port (e.g., an address or other such identification) and the group of virtual functions that are supported by the SR-IOV/S-IOV enabled interface port to a group of virtual machines of host system 120. Each virtual machine of host system 120 can be assigned one virtual function of the interface port. As such, since memory sub-system 110 provides multiple interface ports that each expose a separate group of virtual functions that can be utilized by a different host system, the use of a switch between memory sub-system 110 and host systems 120 is not needed.

In some implementations, multiple ports virtualization component 113 can assign a namespace or a portion of the logical block address space of memory sub-system 110 to each virtual function. For example, each virtual machine that is assigned a virtual function can have access to a different portion of the logical block address space (LBA) of memory sub-system 110. The logical block address space can be mapped to a physical block address space of the memory sub-system. In some implementations, memory sub-system controller 115 can determine that a group of virtual functions are assigned to an interface port with a particular LBA range for each virtual function. In the same or alternative embodiments, controller 115 can modify the number of virtual functions that are assigned to each of the interface ports. For example, the number of virtual functions that can be assigned to virtual machines of a host system coupled with a particular interface port can be increased or decreased based on the usage of the storage resources of memory sub-system 110 by the virtual machines of the host system. In some embodiments, different LBA ranges (e.g., different amount of logical block addresses that are mapped to a corresponding different amount of physical block addresses) can be assigned to different virtual functions. For example, the virtual functions of an interface port can be assigned larger LBA ranges than the virtual functions of another interface port. The different LBA ranges can be based on use of the different virtual machines or applications of the host system connected to the interface port.

In some implementations, each interface port of memory sub-system controller 115 can be coupled with a separate memory buffer of memory sub-system controller 115. This way, controller 115 can divide its bandwidth between the different interface ports, such that all ports can work in parallel. Accordingly, each interface port can temporarily store data received from controller 115 in the buffer assigned to the interface port. Similarly, controller 115 can store data received from a respective interface port in the buffer dedicated to the port until controller 115 is ready to process the data from the port.

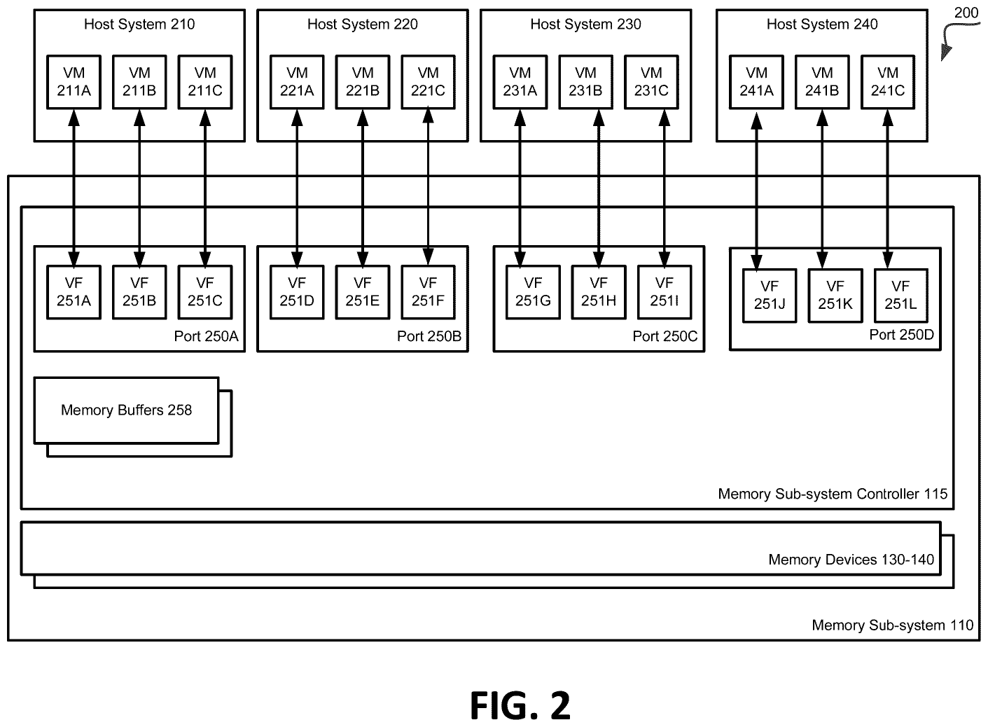

FIG. 2 illustrates an example computing system 200 that includes memory sub-system 110 with multiple ports that have single root virtualization in accordance with some embodiments of the present disclosure. Memory sub-system 110 can be connected to multiple host systems 210-240. Each host system 210-240 can be the same or similar to host system 120 of FIG. 1. In implementations, each host system 210-240 can be a separate system on a chip (SOC) or another host system that provides a group of virtual machines. For example, each host system 210-240 can be a separate processor core or processing device that provides or executes a group of virtual machines. Each host system 210-240 can be coupled with memory sub-system 110 through one of interface ports 250A-D, provided by memory sub-system controller 115 of memory sub-system 110. For example, a PCIe interface can be utilized between each host system and interface port so that each host system 210-240 is coupled with a different interface port 250A-D of the memory sub-system 110. In another example, two host systems can be coupled with a quad interface port 250A-D (e.g., using a separate PCIe switch), thus increasing the number of host systems that can access the memory sub-system 110.

In an illustrative example, hosts systems 210-240 can be systemonchip (SOC) hosts and memory sub-system 110 can have one or more PCIe endpoint ports and one or more ethernet ports. Each interface port can have one lane and can auto detect each link to connect to each host SOC RC (root complex). In implementations, interface port link/lanes combinations can include: 4×ports, 1 lane; 3×ports, 1 lane; 2×ports, 2 lanes; and 1×port, 4 lanes. The PCIe PHY layer can be bifurcated up to four ways, one per interface port in order to share the bandwidth of the backend storage of memory sub-system 110. Each interface port exposes a group of VFs on that port to each host SOC, which in turn has multiple VMs running across its CPUs cores.

In an implementation, interface port 250A can be connected to host system 210. Interface port 250A can be allocated virtual functions (VF) 251A-C. In order to allow for isolation of the resources of shared memory sub-system 110, each VF 251A-C of port 250A can be utilized by one virtual machine (VM) 211A-C of host system 210. In this case, VF 251A can be assigned to VM 211A of host system 210, VF 251B can be assigned to VM 211B of host system 210, and VF 251C can be assigned to VM 211C of host system 210. In implementations, each VF 251A-L of memory sub-system 110 can be allocated a corresponding range of LBA of memory devices 130-140, such that each VF 251A-L has a dedicated namespace in memory sub-system 110.

SR-IOV enabled port 250B can be allocated VFs 251D-F. In order to allow for isolation of the resources used by the different VMs and host systems, each VF 251D-F of port 250B can be utilized by one VM 221A-C of host system 220. In this case, VF 251D can be assigned to VM 221A of host system 220, VF 251E can be assigned to VM 221B of host system 220, and VF 251F can be assigned to VM 221C of host system 220. Similarly, SR-IOV enabled port 250C can be connected to host system 230, and can be allocated VFs 251G-I. VF 251G can be assigned to VM 231A of host system 230, VF 251H can be assigned to VM 231B of host system 230, and VF 251I can be assigned to VM 231C of host system 230. Along the same lines, SR-IOV enabled port 250D can be connected to host system 240, and can be allocated VFs 251J-L. VF 251J can be assigned to VM 241A of host system 240, VF 251K can be assigned to VM 241B of host system 240, and VF 251L can be assigned to VM 241C of host system 240.

In implementations, each VM 211A-C, 221A-C, 231A-C, and 241A-C can use its assigned VF to access a separate namespace within one of memory devices 130-140. For example, each VF 251A-L can be allocated a specific range of LBA of memory devices 130-140a dedicated to that VF. This enables a VM that is associated with the VF to access a separate portion of memory, as explained in more details herein below.

In certain implementations, each interface port 250A-D of memory sub-system controller 115 can be coupled with a separate buffer of memory buffers 258 of controller 115. The separate buffer enables controller 115 to service interface ports 250A-D and isolate data to and from each port, such that interface ports 250A-D can work in parallel. Accordingly, each interface port 250A-D can store data received from controller 115 in a buffer assigned to the interface port for further processing by port 250A-D. Similarly, controller 115 can store data received from a respective interface port in the buffer dedicated to the port until controller 115 is ready to process the data from the port. In an illustrative example, memory buffers 258 enable concurrent memory access requests to be received at interface ports 250A-D. The memory access requests can be held in the associated memory buffer while a current request is being processed at the corresponding interface port. Once the interface port has completed processing of the current request, a next request can be retrieved from the associated memory buffer for processing, and another memory access request can be added to the memory buffer.

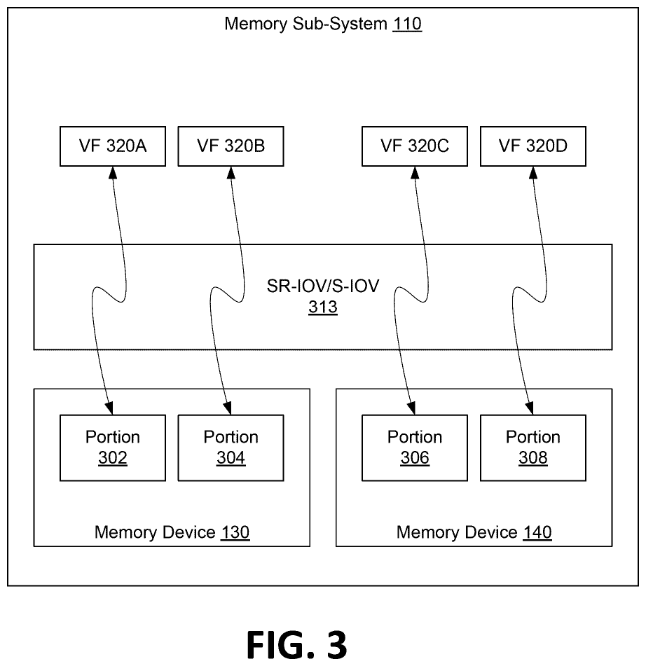

FIG. 3 illustrates virtual functions memory portion mapping in memory sub-system for SR-IOV/S-IOV virtualization in accordance with some embodiments of the present disclosure. As described above, multiple ports virtualization component 113 allocates to each virtual function (VF) 320A-D in the memory sub-system 110 a corresponding portion of one of memory devices 130-140. The multiple VFs 320A-D are provided in the memory sub-system 110 using SR-IOV 313, as explained in more details herein above. As illustrated in FIG. 3, VF 320A is allocated portion 302 of memory device 130, VF 320B is allocated portion 304 of memory device 130, VF 320C is allocated portion 306 of memory device 140, and VF 320D is allocated portion 308 of memory device 140. In other embodiments, the respective portions can span two or more of memory devices 130-140. Each portion 302-308 can have a fixed size or can have a different size. For example, portion 302 could be larger than portion 304, which can be larger than portion 306, which can be the same size as portion 308. In one embodiment, each portion 302-308 is represented by a unique namespace. The namespace is a quantity of one or more memory devices 130-140 that can be formatted into logical blocks (e.g., ranges of LBA space), when memory devices are configured with a NVMe protocol. The NVMe protocol provides access to the namespace, which appears as a standard-block device on which file systems and applications can be deployed without any modification. Each virtual function 320A-D can have one or more separate namespaces, each identified by a unique namespace ID (NSID).

In an illustrative example, memory sub-system 110 can provide an identification of each VF 320A-D (e.g., a virtual PCIe interface or a virtual ethernet interface) that can be supported through the PCIe interface of the device identification. In some embodiments, each portion 302-308 can be arrange of LBA space of memory devices 130-140. Accordingly, each virtual machine of a host system that is assigned a virtual function (e.g., by connecting to the VF using the device identification of the VF) can be assigned a different portion of the logical block address space of memory sub-system 110. The logical block address space can be mapped to a physical block address space of memory sub-system 110.

In some embodiments, controller 115 of memory sub-system 110 can specify that a group of virtual functions are assigned to an interface port with a particular LBA range for each virtual function. In the same or alternative embodiments, the controller can modify the number of virtual functions that are assigned to each of the interface ports. For example, the number of virtual functions that can be provided to virtual machines of a host system coupled with a particular interface port can be increased or decreased based on the usage of the storage resources of the memory sub-system by the virtual machines of the host system. In some embodiments, different LBA ranges (e.g., different amount of logical block addresses that are mapped to a corresponding different amount of physical block addresses) can be assigned to different virtual functions. For example, the virtual functions of an interface port can be assigned larger LBA ranges than the virtual functions of another interface port. The different LBA ranges can be based on use of the different virtual machines or applications of the corresponding host system.

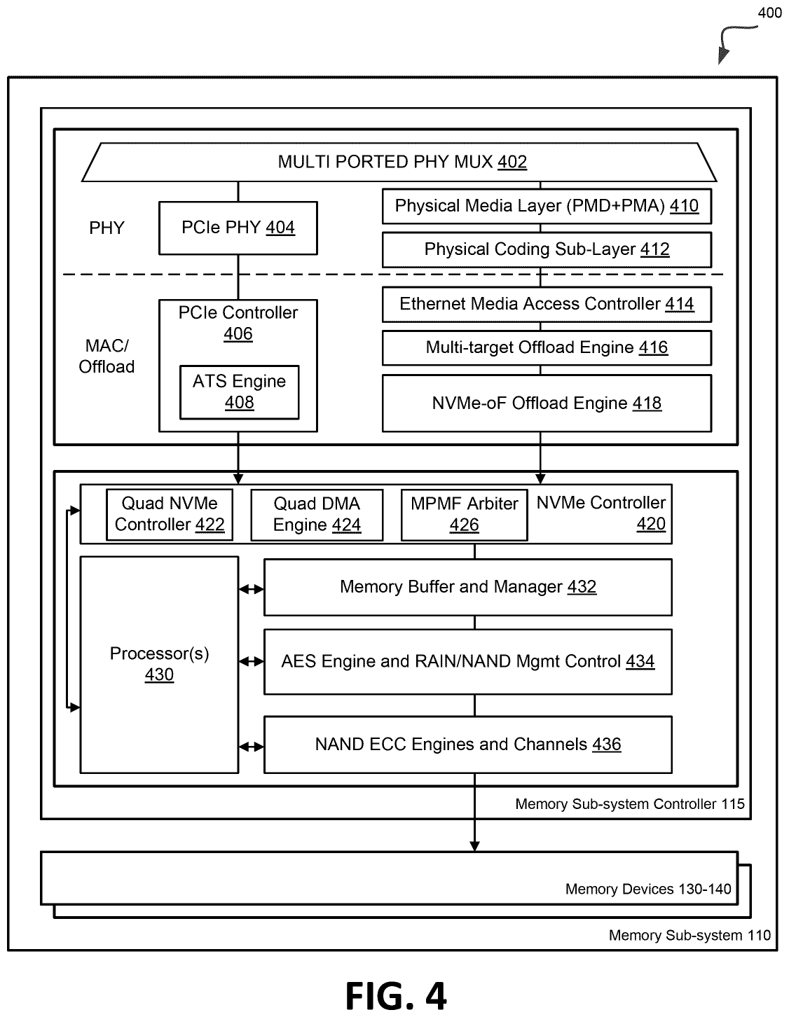

FIG. 4 illustrates an example memory device 400 with a multimodal memory sub-system 110 with multiple ports having scalable virtualization, in accordance with some embodiments of the present disclosure. Memory device 400 includes a multi ported (e.g., quad ported) physical layer (PHY) multiplexer (MUX) 402, which identifies the input signal (e.g., PCIe or Ethernet) and sends a PCIe signal to the PCIe PHY 404 and sends an ethernet signal to physical media layer 410. In some embodiments, the PHY MUX 402 is able to process PCIe and ethernet signals simultaneously, without compromising bandwidth or reliability.

The PHY MUX 402 enables sharing of physical layer resources, such as physical layer (PHY) transceivers, between multiple network interfaces or ports. By using a PHY MUX 402, the number of physical layer resources required is reduced, which can help reduce the overall cost and complexity of the memory sub-system. PHY MUX 402 selectively connects the physical layer resources to the appropriate network interface or port, based on the data flow requirements. For example, if a particular port is transmitting data, the PHY MUX 402 will connect the appropriate physical layer transceiver to that port to enable transmission. Similarly, if a port is receiving data, the PHY MUX 402 will connect the appropriate physical layer transceiver to that port to enable reception.

The PHY MUX 402 may be coupled to a PCIe PHY 404, which is the physical layer interface for peripheral component interconnect express (PCIe). The PCIe PHY 404 is responsible for implementing the physical layer of the PCIe protocol, which includes the electrical, timing, and signaling characteristics of the PCIe interface. The PCIe PHY 404 is responsible for transmitting and receiving data at high speeds between the PCIe devices connected to the memory sub-system 110. The PCIe PHY 404 is also responsible for encoding and decoding the data, as well as for transmitting and receiving the signals on the physical layer of the PCIe interface. In some embodiment, pulse amplitude modulation with four levels, or PAM4 encoding may be used where four voltage levels are used to represent four combinations of two bits logic (00, 01, 10, and 11). PAM4 encoding may be used for some 56 GHz channels and all 112 GHz channels. The PCIe PHY 404 supports multiple lanes (e.g., four lanes), which can be used to increase the overall bandwidth of the PCIe interface. Each lane operates at a specific speed, such as 2.5 Gbps, 5 Gbps, 8 Gbps, or 16 Gbps, depending on the PCIe version and the specific implementation of the PHY.

PHY MUX 402 may be coupled to a PCIe controller 406 that manages communication between processors 430 and the PCIe bus. The PCIe bus may be used to connect various peripheral devices, such as network cards, graphics cards, to one or more processors. The PCIe controller 406 acts as a bridge between the processors 430 and the PCIe bus, allowing the processors 430 to communicate with the peripheral devices connected to the bus. When a peripheral device is connected to the PCIe bus, the PCIe controller 406 assigns it a unique address and manages the transfer of data between the device and the processors 430. The PCIe controller 406 operates by sending and receiving commands and data between the processors 430 and the peripheral devices over the PCIe bus. The controller uses a set of registers to manage the configuration and status of the PCIe devices, and it also provides interrupt handling, error reporting, and power management functions. In some embodiments, the PCIe controller 406 may use a set of rules to determine which request gets access to the bus first, based on factors such as the device's priority level, the type of data being transferred, and the number of other devices currently using the bus.

In some embodiments, the PCIe controller 406 may include an address translation service (ATS) engine 408 that is used to translate virtual addresses into physical addresses. The ATS engine is initialized when the memory sub-system boots up, and it is responsible for maintaining a translation table that maps virtual addresses to physical addresses. When a program running on the memory sub-system needs to access memory, it sends a virtual address to the ATS engine. The ATS engine uses the translation table to look up the corresponding physical address for the virtual address. To improve performance, the ATS engine may cache recently used translations in a cache memory. This allows the ATS engine to quickly translate frequently used virtual addresses without having to access the translation table. The ATS engine may also use coherency protocols to ensure that all processors and devices have a consistent view of the translation table. In the event of a translation error, such as an invalid virtual address, the ATS engine may generate an exception or interrupt to notify the processors 430 of the error.

The PHY MUX 402 may be coupled to a physical media layer (PML) 410, which is a component of a network interface card (NIC) that is responsible for transmitting and receiving data over a physical communication channel. The data to be transmitted is first encoded into a digital format, such as binary, and then modulated onto a carrier wave. The modulation scheme used depends on the type of communication channel and the desired transmission speed. The modulated signal is then transmitted over the physical communication channel. The signal may be amplified, shaped, or filtered along the way to compensate for attenuation, distortion, or interference caused by the channel. The received signal is processed by the PML 410 to extract the original modulated signal. This involves tasks such as demodulation, equalization, and synchronization. The modulated signal is decoded back into its original digital format, and any error correction codes are applied to correct any transmission errors that may have occurred. The decoded data is then passed on to the link layer of the network protocol stack, which adds protocol headers, performs flow control, and manages the transmission of data packets.

PML 410 may be coupled to a physical coding sub-layer (PCS) 412, which is responsible for encoding and decoding data at the bit level. The PCS 412 receives the data from the media access control (MAC) layer and encodes it into a format suitable for transmission over the physical communication channel. This encoding may involve adding error detection and correction codes, scrambling the data to prevent pattern-dependent errors, and ensuring that the data is formatted in a way that can be easily transmitted and received. The encoded data is then mapped onto a specific modulation scheme that is appropriate for the physical communication channel. The modulation scheme may use amplitude, phase, or frequency modulation, depending on the type of channel and the desired transmission speed and reliability. The mapped signal is then transmitted over the physical communication channel. The signal may be amplified, filtered, or otherwise modified to ensure that it is transmitted correctly and can be received by the receiver. The receiver receives the transmitted signal and decodes it back into the original data. The receiver performs the inverse functions of the encoding, mapping, and transmission steps to extract the original data from the signal. The decoded data may contain errors due to noise, interference, or other factors. The PCS 412 performs error correction using the error detection and correction codes that were added during encoding to ensure that the data is received correctly. The error-corrected data is passed up to the MAC layer for delivery to the upper layers of the network protocol stack.

PCS 412 may be coupled to an ethernet media access controller (MAC) 414, which is responsible for controlling access to the shared communication channel. The MAC 414 receives data from the upper layers of the protocol stack and formats it into ethernet frames that include source and destination addresses, frame type, and payload. The MAC 414 checks the destination address of the frame to determine whether it is intended for the local memory device. If the frame is intended for the local memory device, it is processed by the higher layers of the protocol stack. If the frame is intended for another device on the network, the MAC 414 initiates transmission of the frame onto the communication channel. The MAC 414 also checks for collisions on the communication channel by monitoring the channel for other devices that may be transmitting at the same time. If a collision is detected, the MAC 414 waits for a random amount of time before attempting to retransmit the frame. The MAC 414 also manages flow control to ensure that data is transmitted at an appropriate rate. This involves regulating the amount of data that can be transmitted before waiting for an acknowledgment and controlling the rate of transmission based on the network traffic and available bandwidth. The MAC may also perform address resolution to map higher-level addresses, such as IP addresses, to the MAC addresses used in ethernet frames. This involves communicating with other devices on the network to determine their MAC addresses and maintaining a cache of mappings for efficient address resolution.

The ethernet MAC 414 may be coupled to a multi-target offload engine 416, which is used to improve performance and reduce the workload on the processors 430 and/or host system 210-240. The multi-target offload engine 416 may receive both PCIe and ethernet signals, and perform memory copy operations, which involve moving data from one location in the memory to another. The multi-target offload engine 416 can help to accelerate memory copy operations by performing these operations in hardware, without involving the processors 430 and/or host system 210-240. The multi-target offload engine 416 can implement algorithms to move data directly from the source memory location to the destination memory location, bypassing the processors 430 and/or host system 210-240 altogether. This can significantly improve performance and reduce latency, especially for large data sets.

In some embodiments, storing data as data objects may facilitate improving operational efficiency of a computing system by enabling a memory module implemented in the computing system to perform data processing operations, for example, to offload processing performed by host processing circuitry. In particular, memory processing circuitry implemented in the memory module may access (e.g., receive, read, or retrieve) a data object, which includes a data block and metadata. Based at least in part on the metadata, the memory processing circuitry may determine context of the data block and perform data processing operations accordingly. In this manner, memory processing circuitry implemented in a memory module may post-process data by performing data processing (e.g., encoding or compression) operations on the data before storage, which, at least in some instances, may facilitate offloading processing performed by host processing circuitry and, thus, improving operational efficiency of a corresponding computing system. Similarly, memory processing circuitry implemented in a memory module may pre-process data by performing data processing (e.g., decoding and/or de-compression) operations on the data before output, which, at least in some instances, may facilitate offloading processing performed by host processing circuitry and, thus, improving operational efficiency of a corresponding computing system. In addition to offloading (e.g., reducing) processing performed by host processing circuitry, the techniques of the present disclosure may facilitate improving operational efficiency by leveraging data communication efficiency provided by internal buses implemented on a memory module. By implementing and/or operating a memory module in accordance with the techniques described herein, a memory module may perform data processing operations that facilitate offloading (e.g., reducing) processing performed by main (e.g., host) processing circuitry of a computing system. For example, dedicated (e.g., memory) processing circuitry implemented in a memory module may pre-process data before output to the main processing circuitry and/or post-process data received from the main processing circuitry before storage in a memory device of the memory module.

The multi-target offload engine 416 may be coupled to a NVMe over fabric (NMVe-of) offload engine 418 to accelerate the processing of NVMe-oF traffic. When an NVMe-oF packet is received by the NIC, the offload engine 418 decapsulates the packet, separating the NVMe commands and data from the network headers. The offload engine 418 processes the NVMe commands in the packet, forwarding them to the NVMe controller 420 for execution. The offload engine 418 also processes the data in the packet, handling tasks like buffer allocation, data copying, and data integrity verification. In some implementations, the offload engine 418 can also handle Remote Direct Memory Access (RDMA) operations. Once the NVMe command has been executed, the offload engine 418 generates a completion packet and sends it back to the host system. By offloading the processing of NVMe-oF traffic, the offload engine 418 can improve performance and reduce CPU utilization. It can also enable the use of RDMA to further reduce network latency and CPU overhead.

Both PCIe controller 406 and NVMe-oF offload engine 418 connect to a NVMe controller 420, which is responsible for managing the data transfer between the host system and the memory devices 130-140, and for performing various memory management and error correction tasks. The NVMe controller 420 receives commands from the host system over the PCIe interface and processes these commands to read or write data to the memory devices 130-140. Once the controller 420 has processed a command, it manages the transfer of data between the host system and the memory devices 130-140. This involves managing the read and write paths, performing data encryption and decryption if required, and ensuring data integrity. The controller 420 is responsible for managing the memory on the memory devices 130-140, including handling wear leveling and garbage collection. The controller 420 may also perform wear leveling, which is distributing write operations across the memory devices 130-140 to prevent any one area from wearing out prematurely. The controller 420 may also perform garbage collection, which involves identifying blocks of data that are no longer needed and erasing them to free up space. The controller 420 is also responsible for error correction, including detecting and correcting data errors, and handling bad blocks. In some embodiments, the NVMe controller 420 also includes power management features to help reduce power consumption and extend the lifespan of the memory sub-system 110. For example, this may include like power gating, which allows unused parts of the memory devices 130-140 to be turned off when not in use.

The NVMe controller 420 may include a multi-ported (e.g., quad-ported) NVMe controller 422. The NVMe controller may further include a multi-DMA (e.g., quad DMA) engine 424, and a multi-port multi-function (MPMF) arbiter 426. A multi-direct memory access (multi-DMA) engine 424 may accelerate data transfer between different devices, such as between the processors 430 and memory device 130-140, or between processors 430 and I/O devices. When the memory sub-system 110 is first powered on, the multi-DMA engine 424 is initialized and configured based on system parameters. The engine 424 maintains a request queue that holds pending data transfer requests from the processors 430 or I/O devices. When a data transfer request is received, the multi-DMA engine 424 performs the transfer using one or more DMA channels. DMA channels are hardware resources that allow the engine 424 to transfer data directly between devices without involving the processors 430. Once a data transfer is complete, the engine 424 generates an interrupt to signal to the processors 430 that the data is available. The multi-DMA engine 424 includes error handling mechanisms to detect and correct errors that may occur during data transfer. To optimize performance, the multi-DMA engine 424 can use advanced techniques like scatter-gather DMA, which allows data to be transferred from multiple non-contiguous memory locations to a single destination without intermediate copying.

The multi-port multi-function (MPMF) arbiter 426 is responsible for controlling access to shared resources, such as a memory or I/O bus, by multiple devices. The arbiter 426 maintains a request queue that holds pending requests from multiple devices. The arbiter 426 may use a priority scheme to determine which device should be granted access to the shared resource next. The priority scheme can be based on factors like device type, request type, or round-robin scheduling. When a request is received, the arbiter 426 uses the priority scheme to determine which device should be granted access to the shared resource next. The arbiter 426 then sends a grant signal to the selected device, indicating that it has been granted access. The arbiter 426 may include timing and synchronization features to ensure that devices are granted access to the shared resource in a fair and predictable manner. This includes features like fixed arbitration intervals, time slicing, and back-off algorithms. The MPMF arbiter 426 may also include error handling mechanisms to detect and resolve conflicts or errors that may occur during arbitration. The MPMF arbiter 426 can support multiple functions or types of devices by allocating separate resources to each function and managing access to those resources separately.

Device 400 may include one or more processor(s) 430, which may be coupled to a memory buffer and memory manager 432, an Advanced Encryption Standard (AES) engine and RAIN/NAND management control 434, and one or more NAND ECC engines 436. The AES engine 434 may accelerate encryption and decryption operations. Before encryption or decryption can occur, the AES engine 434 may first set up a key. This may involve initializing the key expansion algorithm with the secret key and generating a set of round keys that may be used in the encryption or decryption process. In AES encryption, the plaintext is divided into blocks, and each block is processed using a series of encryption rounds. During each round, the block is transformed using a combination of substitution, permutation, and mixing operations, with the round key added in at various stages. AES decryption involves the reverse process of encryption, with each block being transformed using a series of decryption rounds. During each round, the block is transformed using the inverse of the encryption operations, with the round key added in at the same stages as in encryption. To optimize performance, AES engine 434 can use techniques like pipelining, parallelism, and data caching. Pipelining involves breaking down the encryption or decryption process into stages and processing multiple blocks simultaneously. Parallelism involves using multiple processing units to perform encryption or decryption in parallel. Data caching involves storing frequently used data in a small, high-speed memory to reduce access time. The AES engine 434 may also include error handling mechanisms to detect and correct errors that may occur during encryption or decryption, such as data corruption or key mismatches.

The redundant array of independent NAND (RAIN)/NAND management control 434 may be used to manage the storage and retrieval of data. For example, the NAND flash memory may be organized into blocks, which are composed of multiple pages. The NAND management controller 434 may be responsible for managing these blocks, including wear leveling, error correction, and bad block management. Wear leveling ensures that writes are distributed evenly across all blocks, to prevent premature wear of any one block. Error correction codes are used to detect and correct errors that occur during data transfers, while bad block management involves identifying and marking blocks that are unusable due to physical defects. The NAND management controller 434 is also responsible for managing individual pages within the blocks. This includes performing read and write operations, and handling erase operations. The controller 434 must ensure that data is written and read accurately, and that erased blocks are ready to be reused. Memory devices 130-140 store data in a series of pages and blocks, which must be organized and managed to allow for efficient access and retrieval. The NAND management controller 434 is responsible for organizing data into logical blocks, to make it easier to manage and retrieve data. The NAND management controller 434 interfaces with the host system using a standard interface such as SPI or SDIO. The controller 434 is responsible for managing the communication protocol and ensuring that data is transferred accurately and efficiently between the host system and the flash memory. To optimize performance, NAND management controller 434 can use techniques like data caching, compression, and error correction codes. Data caching involves storing frequently accessed data in a small, high-speed memory to reduce access time. Compression can be used to reduce the amount of data that needs to be written to flash memory, while error correction codes can help to reduce the impact of errors on data integrity.

The one or more NAND error correcting code (ECC) engines and channels 436 may be used to detect and correct errors that occur in NAND flash memory devices. The NAND ECC engine 436 works by adding additional bits of data to each page of memory that is written to the NAND flash device. These additional bits are known as parity or ECC bits, and they are calculated using complex algorithms that are designed to detect and correct errors in the data. When data is read from a NAND flash memory device, the NAND ECC engine 436 reads the data and the parity bits associated with the data. The engine then uses the parity bits to check for errors in the data. If the NAND ECC engine 436 detects an error in the data, it reports the error to the host device, which can then take appropriate action to correct the error. When data is written to a NAND flash memory device, the NAND ECC engine 436 calculates the parity bits based on the data that is being written. The engine then writes the data and the parity bits to the NAND flash memory device. If an error is detected during a subsequent read operation, the NAND ECC engine 436 uses the parity bits to correct the error in the data. This helps to ensure that the data stored on the NAND flash memory device is accurate and reliable.

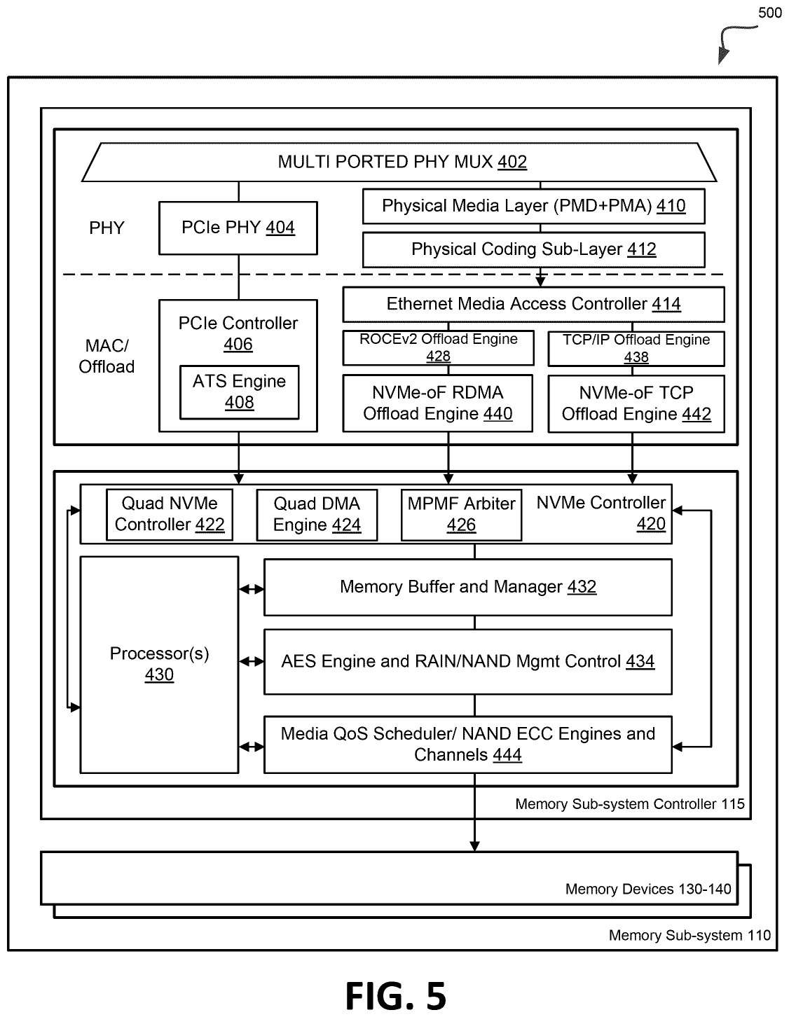

FIG. 5 illustrates an example multimodal memory sub-system 110 with multiple ports that have scalable virtualization, in accordance with some embodiments of the present disclosure. In this embodiment, device 500 is similar to device 400, except that the ethernet media access controller 414 is able to identify the types of ethernet signals received and route it, based on the type of ethernet packet received, to the appropriate offload engine. For example, the ethernet media access controller 414 may identify a remote direct memory access over converged ethernet version 2 (ROCEv2) signal and divert it to ROCEv2 offload engine 428 or identify a TCP/IP data packet and divert it to TCP/IP offload engine 438. ROCEv2 is a protocol that enables the transfer of data between devices connected to the ports and memory devices 130-140 over Ethernet networks with low latency and high bandwidth. The ROCEv2 offload engine 428 improves performance and reduce the workload on the processors 430 and/or host system 210-240. The ROCEv2 offload engine 428 perform memory copy operations, which involve moving data from one location in the memory to another. The ROCEv2 offload engine 428 can help to accelerate memory copy operations by performing these operations in hardware, without involving the processors 430 and/or host system 210-240. The ROCEv2 offload engine 428 can implement algorithms to move data directly from the source memory location to the destination memory location, bypassing the processors 430 and/or host system 210-240 altogether. This can significantly improve performance and reduce latency, especially for large data sets.

The ROCE v2 offload engine 428 may then forward the ROCEv2 data packet to the NVMe-of Remote Direct Memory Access (RDMA) offload engine 440 because the ROCEv2 contains one or more RDMA packets. An NVMe-oF RDMA 440 offload engine accelerates the NVMe-oF protocol by offloading some of the processing from the host systems 210-240 to the offload engine 440. The NVMe-oF RDMA offload engine 440 is initialized by software driver of the host systems 210-240. The driver sets up the necessary parameters for the offload engine, such as the target IP address and the size of the data to be transferred. When the software driver wants to transfer data, it sends a request to the NVMe-oF RDMA offload engine 440. The offload engine 440 then takes over the data transfer process, sending the data to the target system using the NVMe-oF protocol. The NVMe-oF RDMA offload engine 440 performs various functions to offload the processing from the host systems 210-240, including setting up the RDMA connection, performing data segmentation and reassembly, and handling flow control.

Once the data transfer is complete, the NVMe-oF RDMA offload engine 440 sends an acknowledgment message to the host software driver to confirm that the data has been successfully transferred. By offloading some of the processing from the host CPU to the offload engine, the NVMe-oF protocol can be accelerated, reducing latency and increasing bandwidth.

Similarly, the TCP/IP offload engine 438 may forward the TCP/IP packets to the NVMe-of TCP offload engine 442 because the signal includes TCP/IP packets. An NVMe-oF (NVMe-oF) TCP offload engine (TOE) 442 accelerates the NVMe-oF protocol over TCP/IP networks by offloading some of the processing from the host systems 210-240 to the offload engine.

In this embodiment, the one or more NAND ECC engines and channels 436 may include a media QoS scheduler 444, which assigns, based on a QoS (quality of service) requirement of a type of media, a priority level from a plurality of priority levels to the type of media. A media quality of service (QoS) scheduler 444 manages the transmission of multimedia data, such as video or audio, with different levels of priority to ensure that the quality of service for each stream is maintained. The media QoS scheduler 444 first classifies incoming traffic into different priority levels based on the type of media and the quality requirements for that media. The media QoS scheduler 444 then uses traffic shaping to limit the amount of traffic for each priority level to a predetermined maximum bandwidth.

In some embodiments, the multi-port multi-function (MPMF) arbiter 426 may include a quality of service (QoS) bandwidth control component. Quality of Service (QoS) bandwidth control may be used to allocate and prioritize bandwidth on a network to ensure that critical applications get the necessary bandwidth they need to function properly. The QoS bandwidth control classifies traffic into different categories based on their priority. This can be done by examining packet headers or by using application-level information to identify traffic flows. Once traffic has been classified, the QoS bandwidth controller can allocate bandwidth to each traffic category based on their priority. This can be done using a variety of techniques, such as rate limiting, traffic shaping, or traffic policing.

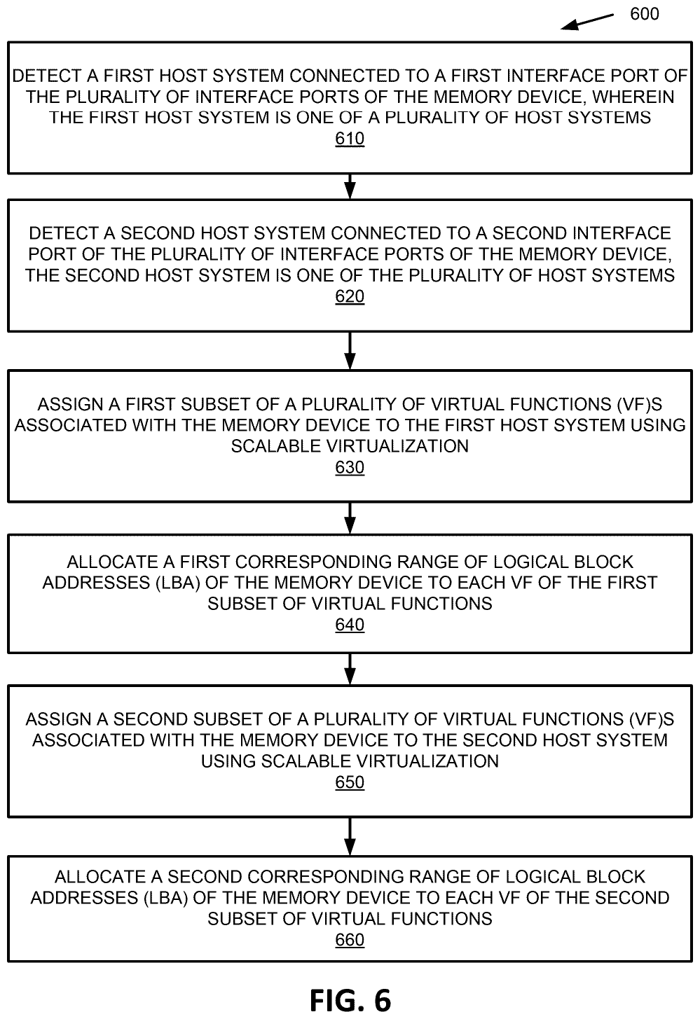

FIG. 6 is a flow diagram of an example method of managing multiple SR-IOV/S-IOV enabled interface ports of a memory sub-system, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by multiple SR-IOV/S-IOV ports component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic detects a first host system that is one of the multiple host systems that can be connected to a memory device. The first host system is connected to a first interface port of multiple interface ports of the memory device. In one implementation, the first interface port can be a Peripheral Component Interconnect Express (PCIe) port, and each PCIe port is SR-IOV/S-IOV enabled, as explained in more details herein above.

In one example, the multiple interface ports can be accessed concurrently by the multiple host systems without the need for a separate switch or bridge. Therefore, the memory sub-system can provide simultaneous access to its storage devices to the host systems using the multiple interface ports, as explained in more details herein.

At operation 620, the processing logic detects a second host system that is one of the multiple host systems that can be connected to a memory device. The second host system is connected to a second interface port of multiple interface ports of the memory device, the second interface port is different than the first interface port of the memory device. In one implementation, the second interface port can be an ethernet port, and each ethernet port is SR-IOV/S-IOV enabled, as explained in more details herein above.

At operation 630, the processing logic assigns a first subset of virtual functions (VF)s associated with the memory device to the first host system using root input/output virtualization (SR-IOV). In implementations, the first subset of VFs corresponds to a group of virtual PCIe interfaces that share physical resources of each interface port. Additionally, for each of the multiple host systems, the processing logic can assign a corresponding VF of the corresponding subset of VFs assigned to the respective host system to a corresponding virtual machine of the multiple virtual machines running on the respective host system, as described in more details herein.

At operation 640, the processing logic allocates a first corresponding range of logical block addresses (LBA) of the memory device to each VF of the first subset of virtual functions assigned to the first host system. In implementations, the logical block address space can be mapped to a physical block address space of one or more memory devices of the memory sub-system, as explained in more details herein above.

At operation 650, the processing logic assigns a second subset of virtual functions (VF)s associated with the memory device to the second host system using root input/output virtualization (SR-IOV). In implementations, the second subset of VFs corresponds to a group of virtual ethernet interfaces that share physical resources of each ethernet port. Additionally, for each of the multiple host systems, the processing logic can assign a corresponding VF of the corresponding subset of VFs assigned to the respective host system to a corresponding virtual machine of the multiple virtual machines running on the respective host system, as described in more details herein.

At operation 660, the processing logic allocates a second range of logical block addresses (LBA) of the memory device to each VF of the second subset of virtual functions assigned to the second host system. In implementations, the logical block address space can be mapped to a physical block address space of one or more memory devices of the memory sub-system, as explained in more details herein above.

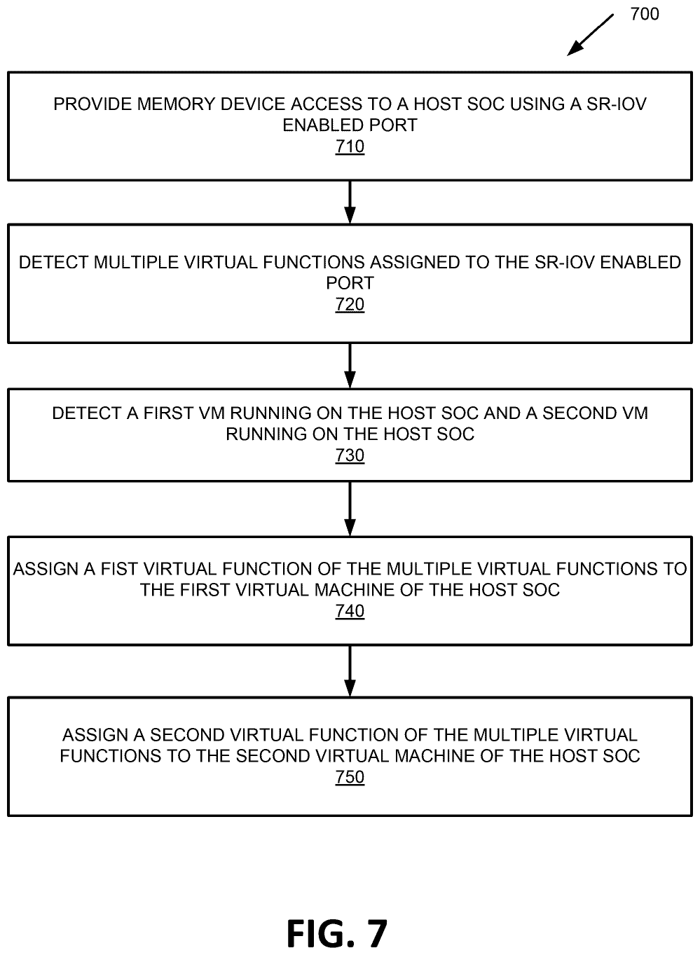

FIG. 7 an example method of assigning virtual functions to virtual machines, in support of multiple SR-IOV enabled interface ports of a memory sub-system, in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by multiple ports virtualization component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 710, the processing logic provides memory device access to a host SOC using a SR-IOV enabled port. In implementations, the memory sub-system can detect that a host SOC is connected to a PCIe port of the multiple PCIe ports of the memory subsystem, as described in more details herein. Further, in response to detecting the host SOC, the memory sub-system can assign a PCIe port to the host SOC by providing a device identification of the SR-IOV enabled PCIe port to the host SOC.

At operation 720, the processing logic detects multiple virtual functions assigned to the PCIe port. In implementations, the memory sub-system can identify the virtual functions that are supported by the PCIe bus or interface. For example, the memory sub-system can provide an identification of each virtual function (e.g., a virtual PCIe interface) that can be supported through the PCIe interface of the identified port, as described in more details herein.

At operation 730, the processing logic detects a first virtual machine (VM) and a second VM running on the host SOC. In implementations, each VM of the host SOC can be assigned a dedicated VF of the PCIe port, in order for the VM to access a corresponding portion of the storage space of the memory sub-system. Thus, at operation 740, the processing logic assigns a first VF of the multiple virtual functions of the PCIe port to the first VM of the host SOC. All memory access requests from the first VM are serviced by the first VF of the PCIe port. Similarly, at operation 750, the processing logic assigns a second VF of the multiple virtual functions of the PCIe port to the second VM of the host SOC. All memory access requests from the second VM are serviced by the second VF of the PCIe port. As explained in more details herein, each VM can have a dedicated portion of the memory devices of the memory sub-system by using its assigned VF of the PCIe port assigned to the respective host SOC.

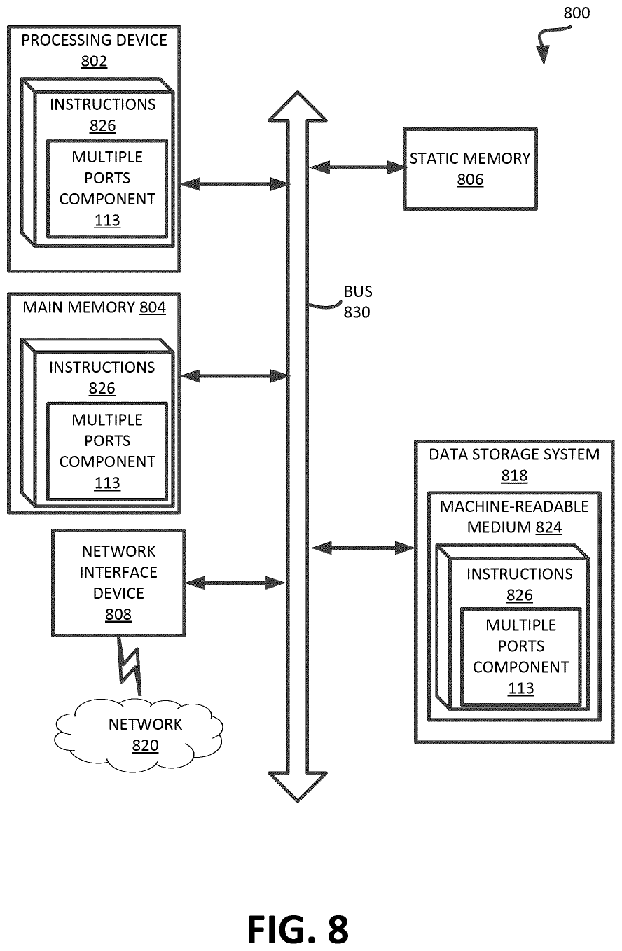

FIG. 8 illustrates an example machine of a computer system 800 within which a set of instructions, for causing the machine to perform any one or more of the methodologies discussed herein, can be executed. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to multiple ports virtualization component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In one embodiment, the instructions 826 include instructions to implement functionality corresponding to multiple SR-IOV/S-IOV ports component 113 of FIG. 1. While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device;
a plurality of interface ports operatively coupled with the memory device; and
a processing device, operatively coupled with the memory device, to perform operations comprising:
identifying a first host system connected to a first interface port of the plurality of interface ports of the memory device, wherein the first interface port comprises a Peripheral Component Interconnect Express (PCIe) port, wherein the first host system runs a plurality of first virtual machines (VMs);
identifying a second host system connected to a second interface port of the plurality of interface ports of the memory device, wherein the second interface port comprises an Ethernet port, wherein the second host system runs a plurality of second VMs;
assigning a first subset of a plurality of virtual functions (VFs) associated with the memory device to the first host system;
allocating a first range of logical block addresses (LBA) of the memory device to each VF of the first subset of virtual functions;
assigning a second subset of the plurality of VFs associated with the memory device to the second host system;
allocating a second range of LBAs of the memory device to each VF of the second subset of virtual functions;
assigning a first VF of the first subset of the plurality of VFs to a first VM of the plurality of first VMs of the first host system; and
assigning a second VF of the second subset of the plurality of VFs to a second VM of the plurality of second VMS of the second host system, wherein the first subset of the plurality of VFs corresponds to a plurality of virtual PCIe interfaces that share physical resources of the PCIe port and a second subset of the plurality of VFs corresponds to a plurality of virtual Ethernet interfaces that share physical resources of the Ethernet port.

2. The system of claim 1, wherein the plurality of VFs are represented by at least one of scalable input/output virtualization (S-IOV) VFs, single root input/output virtualization (SR-IOV), multi-physical function (Multi-PF) virtualization VFs, or multi-target network function virtualization (NFV) VFs.

3. The system of claim 2, wherein the first interface port and the second interface port are enabled by at least one of S-IOV or SR-IOV.

4. The system of claim 1, the operations further comprise:
routing an Ethernet signal from the second interface port to a physical media layer transceiver of a memory sub-system controller; and
routing the ethernet signal from the physical medial layer transceiver to an ethernet media access controller of the memory sub-system controller.

5. The system of claim 4, the processing device to further perform operations comprising:
identifying, based on a header of a frame decoded from the Ethernet signal, a first type of the Ethernet frame;
routing the first type of ethernet signal to a first offload engine running on a network adapter of an output interface.

6. The system of claim 1, the processing device to further perform operations comprising:
assigning, based on a QoS (quality of service) requirement of a type of a frame decoded from the Ethernet signal, a priority level from a plurality of priority levels to the type of data.

7. The system of claim 1, wherein the plurality of host systems are provided access to the memory device without a separate switch or a separate bridge.

8. A method comprising:
detecting, by a processing device, a first host system connected to a first interface port of the plurality of interface ports of the memory device, wherein the first interface port comprises a Peripheral Component Interconnect Express (PCIe) port, wherein the first host system is one of a plurality of host systems;
detecting a second host system connected to a second interface port of the plurality of interface ports of the memory device, wherein the second interface port comprises an ethernet port, wherein the second host system is one of the plurality of host systems;
assigning a first subset of a plurality of virtual functions (VF)s associated with the memory device to the first host system using virtualization;
allocating a first corresponding range of logical block addresses (LBA) of the memory device to each VF of the first subset of virtual functions;
assigning a second subset of the plurality of VFs associated with the memory device to the second host system using the virtualization; and
allocating a second corresponding range of LBAs of the memory device to each VF of the second subset of virtual functions.

9. The method of claim 8, wherein the plurality of VFs are represented by at least one of scalable input/output virtualization (S-IOV), single root input/output virtualization (SR-IOV), multi-physical function (Multi-PF) virtualization, or multi-target network function virtualization (NFV).

10. The method of claim 9, wherein the first interface port and the second interface port are S-IOV enabled or SR-IOV enabled.

11. The method of claim 8, wherein a first subset of VFs correspond to a plurality of virtual PCIe interfaces that share physical resources of the PCIe port and a second subset of VFs correspond to a plurality of virtual ethernet interfaces that share physical resources of the ethernet port.

12. The method of claim 8, further comprising:
assigning a first VF of the first subset of the plurality of VFs to a first VM of the plurality of first VMs of the first host system; and
assigning a second VF of the second subset of the plurality of VFs to a second VM of the plurality of second VMS of the second host system.

13. The method of claim 8, further comprising:
routing an ethernet signal from the second interface port to a physical media layer transceiver of a memory sub-system controller; and
routing the ethernet signal from the physical medial layer transceiver to an ethernet media access controller of the memory sub-system controller.

14. The method of claim 13, further comprising:
identifying, based on a header in the ethernet signal, a first type of ethernet signal;
routing the first type of ethernet signal to a first offload engine running on a network adapter of an output interface;
identifying, based on the header in the ethernet signal, a second type of ethernet signal; and
routing the second type of ethernet signal to a second offload engine running on the network adapter of the output interface.

15. The method of claim 8, wherein the plurality of host systems are provided access to the memory device without a separate switch or a separate bridge.

16. A system comprising:
a memory device;
a plurality of interface ports operatively coupled with the memory device; and
a processing device, operatively coupled with the memory device, to perform operations comprising:
providing access to a plurality of host systems that utilize a memory device using a plurality of interface ports of the memory device, wherein the plurality of interface ports comprise at least a Peripheral Component Interconnect Express (PCIe) port and an ethernet port, wherein each interface port of the plurality of interface ports connects to a separate host system of the plurality of host systems; and
assigning a corresponding subset of a plurality of virtual functions (VFs) of the memory device to each host system of the plurality of host systems using virtualization.

17. The system of claim 16, wherein for each host system of the plurality of host systems, the processing device to further perform operations comprising:
assigning a corresponding range of logical block addresses (LBA) of the memory device to each virtual function of the corresponding subset of virtual functions assigned to the respective host system.

18. The system of claim 16, wherein the virtualization comprises at least one of scalable input/output virtualization (S-IOV), single root input/output virtualization (SR-IOV), multi-physical function (Multi-PF) virtualization, or multi-target network function virtualization (NFV).

19. The system of claim 18, wherein the PCIe port and the ethernet port are S-IOV or SR-IOV enabled.

20. The system of claim 16, the processing device to further perform operations comprising:
assigning a first VF of the first subset of the plurality of VFs to a first VM of the plurality of first VMs of the first host system; and
assigning a second VF of the second subset of the plurality of VFs to a second VM of the plurality of second VMS of the second host system.
